(19) United States
(12) Patent Application Publication
(10) Pub. No.: US 2020/0162263 A1
(43) Pub. Date: May 21, 2020

(54) SYSTEM AND METHOD OF VALIDATION OF BLOCK CHAIN BY SECONDARY CHAIN HAVING INCENTIVIZATION AND INSURANCE COVERAGE POWERED BY PROOF OF WORK

(71) Applicant: ELEVEN01 INTERNATIONAL LIMITED, ST. JULIANS STJ (MT)

(72) Inventor: RAMACHANDRAN IYER, HYDERABAD (IN)

(21) Appl. No.: 16/245,358

(22) Filed: Jan. 11, 2019

(30) Foreign Application Priority Data
Nov. 15, 2018 (IN) 201841043043

(51) Int. Cl. H04L 9/32; G06F 16/27

(52) U.S. Cl. CPC H04L 9/3236; H04L 2209/56; H04L 2209/38; G06F 16/27

(57) ABSTRACT

The invention discloses a system and method of validation of main block chain by secondary chain, a supervisory chain connected to a set of nodes where transactions are recorded and validated, is a cloud-based hardware machine powered by Proof of Work. It comprises a memory device; a processing device operatively coupled to the memory device; storage and other connecting serial and parallel logical buses for transmission of data between various hardware components and configured to execute computer-readable program code. The Supervisory-Chain picks up committed blocks and re-validates all the transactions and their hashes to ensure that the validators have done the right job on the main block chain. There is provision for incentivization in the form of rewards to those continues to do the supervision work and flag transactions that are suspicious and penalty for non-fair users, by way of reduced Fair-Quotient-Score. There is built in insurance pool for rewarding incentive.

### CROSS-REFERENCE TO RELATED APPLICATION

This application claims the benefit of complete patent application having Patent Application No. 201841043043 filed on Nov. 15, 2018 in India.

### FIELD OF INVENTION

The invention relates to a system and method of validation of block chain by secondary chain. More especially it relates to creation of SCVF-(Secondary Chain Validation framework-01), using supervisor-chain (S-Chain) for double-validation and enhanced security powered by PoW with an integrated Insurance pool built in. The second layer of security cover on top of existing proof consensus on main chain, using Proof Of Work as the underlying proof mechanism is built in the system. It creates a true and new layer of security which has been missing in the blockchain platform ecosystem. This will allow for increased security and trust for users of the network, increased avenues to flag dodgy transactions, to call out non-fair users (NFU), and also bake in a mechanism where there is always an insurance pool that's kept aside as contingency for taking up fair-users, if they have been cheated or if for some reason there has been a breach and a fair-user has lost some of his crypto assets. Crypto assets are cryptocurrency holdings of users in their digital wallet.

It includes a custom hardware device that will be deployed in the S-Chain network and main-chain, which will be used to monitor the health of their respective network and also perform data analytics and other algorithmic predictions based on the type of transactions and user data that form the transaction set for the blocks.

### BACKGROUND OF THE INVENTION

The world of blockchain is mostly associated with Bitcoin as the origination, which for most part is true, but most of them miss out on some of the fundamental features that laid the ground and framework that got created because of the solid technology that got built. Blockchain essentially is a chain of blocks that is cryptographically bound together and creates a logical pool of blocks which are validated by a process called consensus. Consensus is at the heart of what forms the characteristic and nature and the very fabric of decentralized network.

Theses Blockchain worked very well till the number of transactions was good enough to serve limited number of applications and hence the limited number of transactions it supports. The problem started when blockchain caught the attention of serious applications and the traffic started increasing on the transactions. This is when the importance of increased security and the trust for users of the network come into play, as it opened avenues for dodgy transactions by the non-fair users.

So the race for new ways of finding consensus started, which include the likes of Proof-Of-Stake, Proof-Of-Resource, Proof-Of-Elapsed Time, Proof-Of-Authority Proof-Of Work, Delegated Proof Of Stake, etc. However, these algorithms alone cannot solve the problem of entry of non fair user's with their doggy transactions. Hence there is scope for improvement in the Blockchain ecosystem.

### PRIOR ART DOCUMENTS

No doubt there are a number of prior art patents/patent applications available related block chain ecosystem. Following patents/patent applications are related to the present field of invention, but novelty wise totally different, which are mentioned here by way of reference.

US20160028552A1 relates to block chain technology. Specifically, this invention relates to creating a block chain called a slide chain that allows for multiple valid branches or forks to propagate simultaneously with a customized set of protocol rules embedded in and applied to each fork chain that branches from another chain. The invention generally provides a computer-implemented method for accessing, developing and maintaining a decentralized database through a peer-to-peer network, to preserve the original state of data inputs while adapting to changing circumstances, user preferences, and emerging technological capabilities.

US 20170244721 A1 relates to a system for providing levels of security access to a process data network that enable a system to determine, authorize, and adjust access, writing, retrieval, and validation rights of users and entities associated with one or more distributed block chain networks. The system is capable of receiving an authorization request from a user to conduct an action associated with the block chain distributed network, determine a security level associated with the user, and either authorize or screen the user from conducting the action based on the determined security level. The system may adjust the security level of the user by requesting and receiving additional authorization credentials from the user. Furthermore, the system may adjust the security level of one or more users based on security or functionality needs of the block chain distributed network.

20150332283 discloses a healthcare transaction validation systems and methods are presented. Healthcare transactions associated with a stakeholder are compiled into a chain of healthcare transaction blocks. The chain can be considered a chronicle of person's healthcare path through life. When a transaction is conducted, the corresponding healthcare parameters (e.g., inputs, outputs, clinical evidence, outcomes, etc.) are sent to one or more validation devices. The devices establish a validity of the transaction and generate a new block via a proof-of-work principle. Once the new block has been calculated it can be appended to the stakeholder's health care block chain.

CN107079058A discloses a service execution method and device of block chain nodes and a node apparatus. The method comprises the following steps: establishing connection with found one or more main charge nodes, the main charge nodes being full nodes in a block chain network; and when a target service needs to be executed, calling a function interface, corresponding to the target service, provided by the one or more main charge nodes or sending a request to the one or more main charge nodes so that the target service is executed through the one or more main charge nodes, wherein the request includes information needed to execute the target service. Corresponding functions are realized for thin nodes through the main charge nodes, so the thin nodes do not need to synchronize with any block head or block data. No matter when the nodes are launched, corresponding services are carried out once the nodes are launched without synchronization of blocks. In this way, the efficiency is improved, and the time is saved. Moreover, block synchronization does not need to be carried out continuously, the quantity of electricity and the network flow can be saved, and the user experience can be improved.

US 2015/0332283 A1 relates to healthcare transaction validation systems and methods are presented. Healthcare transactions associated with a stakeholder are compiled into a chain of healthcare transaction blocks. The chain can be considered a chronicle of person's healthcare path through life. When a transaction is conducted, the corresponding healthcare parameters (e.g., inputs, outputs, clinical evidence, outcomes, etc.) are sent to one or more validation devices. The devices establish a validity of the transaction and generate a new block via a proof-of-work principle. Once the new block has been calculated it can be appended to the stakeholder's health care block chain.

US 2016/0218879 A1 relates to systems, methods, and apparatuses are described wherein a block chain or block chain network can be created and the mining of new blocks can be limited to certain actors holding a specific set of private keys and Verified by the corresponding public keys accessible to consumers interested in validating the block chain. These keys are stored in software or on specific hardware devices designed to not reveal the private key. Only blocks mined using those keys are acceptable on the block chain. The signing of the blocks in the particular block chain is integrated in such a fashion as to be integral to the proof of work for the block chain.

US20170302663A1 relates, to a device in a network receives a network registration request from a particular node. The network registration request comprises information about the particular node. The device causes performance of a validation of the information about the particular node via comparison of the information about the particular node to a distributed block chain that includes information regarding the particular node and one or more other nodes. The device causes an update to the block chain based on the information about the particular node and the validation of the information about the particular node. The device uses the updated block chain to control behavior of the particular node and the one or more other nodes.

As can be seen from the above prior art, the idea stems from the fact that, today blockchain networks use a single layer of block validation, validated by a single proof of consensus model, which still has enough vulnerability and weakness to be exploited by smart system gamers and by groups forming node level alliance to fabricate non-fair transactions and get it validated in the system. This obviously leads to double spending which is an obvious issue. There is also an issue of system hacking which is still very real, given the numerous reported hacks in the blockchain world. The other large issue with blockchain immutability is that no one can go back and un-do a wrong transaction, if for whatever reason it was validated and committed, either by mistake or by oversight or by smart non-fair-user (NFU), who gamed the system.

### THE OBJECTIVE OF THE INVENTION

The main objective of the invention is to help to increase the performance and efficiency of the blockchain network.

Another other objective of the invention is to have a second layer of validation that's carried out by a supervisor-chain that runs a Proof of work consensus algorithm.

Yet another objective of the invention is that a supervisory-Chain which runs parallel in close cascaded fashion and continues to shadow the main-chain, but always stays behind and follows it.

One more objective of the invention is to ensure fairness and an additional layer of security against non-fair-user (NFU) who always finds newer ways to game the public blockchain network.

Another objective of the invention is to have off-chain governance including penalty for non-fair users, by way of reduced Fair-Quotient-Score (FQS) and even banning the user for a temporary period commensurate to the laid-out governance rule.

One more objective of the invention is incentivize the S-Chain miners by providing coin rewards to ensure they continue to do the supervision work and flag transactions that are suspicious, or they find a NFU (Non-Fair-User) who individually or in conjunction with a group trying to game the platform.

Yet another objective of the invention is to have built-in insurance pool, solely kept for rewarding the community and settling fair claims of genuine users and for token stolen, lost or hacked with enough evidence and proof.

### SUMMARY OF THE INVENTION

Today, blockchain networks use a single layer of block validation, validated by a single proof consensus model, which still has enough vulnerability and weakness to be exploited by smart system gamers and by groups forming node level alliance to fabricate non-fair transactions and get it validated in the system. Ours is the first and unique way of solving multitude of these issues faced in the blockchain ecosystem.

We intend to solve this problem by having a second layer of validation that's carried out by a supervisor-chain. The S-Chain runs a Proof of work consensus algorithm which makes use of mining mechanism for rewarding the community and run validation of validated transactions in blocks that are committed. The system is having built-in insurance pool, solely kept for rewarding the community and settling fair claims of genuine users and for token stolen, lost or hacked with enough evidence and proof. Further it is provided with off-chain governance including penalty for non-fair users, by way of reduced Fair-Quotient-Score (FQS) and even banning the user for a temporary period commensurate to the laid-out governance rule.

The S-Chain is a parallel chain which runs in close cascaded fashion and continues to shadow the main-chain, but always stays behind and follows it per design. The S-Chain main role is to validate the already validated set of transactions which have been committed in the block, by a new and different set of nodes to ensure increased scrutiny, fairness and an additional layer of security against non-fair-user (NFU) who are always finding newer ways to game the public blockchain network. The S-Chain runs a standard proof of work algorithm which is based on users running mining machines and solving calculations which eventually leads to validating the transactions. The idea is uncover any wrong doing which occurs in the main chain, which is either by mistake or with an malign intend to double-spend or do other things that compromise the sanctity and governance of the platform. To incentivize the S-Chain miners the system provides coin rewards to ensure they continue to do the supervision work and flag transactions that are suspicious or they find a NFU (Non-Fair-User) who individually or in conjunction with a group trying to game the platform.

Method of functioning/operation of the system comprise of the following steps:
a) progressing with its basic function of adding transactions to block, getting the block validated and getting in committed to the chain, by the main chain;
b) picking up committed blocks by the S-Chain and re-validates all the transactions and their hashes to ensure the validators on the main chain have done the job right;
c) intimating the governance function of the discrepancy, incase some discrepancy is found during the block validation by the cascading parallel chain (S-Chain);
d) kicking in the governance function and does the 2 specific activities of:
   i) running through the run-engine which is part of the meta-governance and
   ii) allowing for administrative intervention to potentially settle the raised grievance;
e) settling the erroneous claims or issue that could be loss of asset due to hacking, or illegally claimed double spending, in accordance of the meta-governance; and
f) settling the claims from the insurance pool that's kept aside as part of the S-Chain insurance cover.

### BRIEF DESCRIPTION OF DRAWING

Other features and advantages of the present invention should become apparent from the following description of the preferred process and read in conjunction with the accompanying drawings, which illustrate, Blockchain consensus mechanism.

FIG. 1 show cases both the mainchain and the supervisor-chain which is shown in cascaded fashion.

FIG. 2 Shows Blocks with connected block hash and merkle tree Wherein 1—Main Chain; 2—Supervisor Chain; 3—Nth Block; 4—Mth Block; 5—sMth Block.

### DETAILS OF THE INVENTION

The invention relates to a new framework that combines a novel way of using a secondary chain called supervisor-chain, which will exist in tandem, but work independently and will have a different set of users and node and help re-validate existing set of transactions and blocks, which get validated and committed to block.

NODES: Nodes are any general purpose computer machines which register and become part of the Blockchain ecosystem. The Nodes can register by themselves if it's part of the public instance of the Blockchain protocol or they will get invited if they are part of the permissioned instance of the Blockchain system.

CRYPTO-ASSET: Crypto-Asset is the associated token that the user/node is ready to stake as part of the Blockchain system. The crypto-asset forms one of the variables in the weighted scheme of things, when the leader is picked.

FAIR-QUOTIENT-SCORE (FQS): Fair-Quotient-Score of a node is built over a period of time based on multiple factors, which includes, the number of blocks validated, the number of blocks committed, number of fair claims raised, % of node uptime, frequency of voting right exercised, fair-points received from fellow node users. The weightage on each can be tweaked based on platform need and use-case.

The framework also provides for a mechanism to incentivize the Supervisory-Chain miners by providing coin rewards to ensure they continue to do the supervision work and flag transactions that are suspicious or they find a NFU (Non-Fair-User) who individually or in conjunction with a group trying to game the platform. The framework is also combined with an insurance mechanism, where there is a governance structure that allows for a security amount to be kept aside which can be used to dip into and compensate Fair-users who may have suffered financial loss due to theft, within a permissible limit. This framework is one of the unique features of the invention which can be used by multiple blockchain protocol to implement a second layer Supervisor-chain, which strengthens the fairness and governance of the underlying platform.

According to our invention we disclose a system and method of secondary chain validation which is a parallel chain that runs in close cascaded fashion and continues to shadow the main-block chain, but always stays behind and follows it as per design to validate and incentivize and provided with insurance pool coverage powered by Proof of Work where in both main chain and secondary chain that functions as supervisory chain connected set of nodes where transactions are recorded and validated, which is a cloud based hardware machine comprising a memory device; a processing device operatively coupled to the memory device, a storage and other connecting serial and parallel logical buses for transmission of data between various hardware components wherein the processing device is configured to execute computer-readable program code to ensure the working of double validation process once the system is has committed the block validating the transactions the Supervisory-Chain picks up committed blocks and re-validates all the transactions and their hashes to ensure the validators on the main chain have done the right job.

According to an aspect of the invention, the system provides unique double layer security framework using two cascaded layering of consensus proof mechanism in a private and permissioned Blockchain environment.

According to another aspect of the invention, unique double layer security framework using two cascaded layering of consensus proof mechanism in a public block chain environment is provided.

According to yet another aspect of the invention, a mechanism is provided in the system to revalidate the already validated or committed user transaction by an out of chain governance mechanism by a supervisor-chain.

According to one aspect of the invention, mechanism of supervisor chain model, additional layer of supervision and control is maintained and managed to increase security and trust.

According to an aspect of the invention, there is provided a mechanism to revalidate the already validated or committed user transaction by an on-chain governance mechanism.

According to another aspect of the invention, the system is revalidated by PoW supervisor-chain, by on-chain governance mechanism, using penalty and increased cost of transaction.

According to one more aspect of the invention, the system is revalidated by on-chain governance mechanism, using penalty and increased cost of transaction.

According to another aspect of the invention, system revalidates the already validated or committed user transaction by an out of chain governance mechanism.

According to one more aspect of the invention, off-chain governance of the system, includes penalty for non-fair users, by way of reduced Fair-Quotient-Score (FQS).

According to an aspect of the invention, off-chain governance of the system includes penalty for non-fair-users (NFU) by way of banning the user for a temporary period commensurate to the laid-out governance rule.

According to another aspect of the invention, Off-chain governance of the system includes penalty for non-fair users, by way of permanently banning non-fair-user (NFU) for repeat offense and if falls under the governance purview of banning.

According to an aspect of the invention, means are there for providing additional layer of security and additional layer of transaction validation, for increasing the governance aspect of the platform.

According to another aspect of the invention, means are there for providing incentive on the supervisor-chain by means of mining reward token, using Proof of Work or a similar consensus model.

According to an aspect of the invention, mechanism is in place for using Proof of work as a consensus model for incentivize behaviors, outside of the main-chain in a blockchain platform.

According to one more aspect of the invention mechanism of combining and using two parallel consensus model in the blockchain platform are in place in the system.

According to another aspect of the invention, system uses two parallel consensus model, which validate transactions in a cascaded fashion.

According to an aspect of the invention, parallel and cascaded mechanism run two distinct consensus algorithm and are tuned by administrative levers to manage the cascading window frame.

According to one aspect of the invention, an additional layer of decentralized on-chain governance layer is in place which is based on re-validation of validated transactions.

According to an aspect of the invention, the unique mechanism brings an additional layer of non-decentralized off-chain governance layer which is based on re-validation of validated transactions.

According to another aspect of the invention, a built in insurance pool having a part of the token raised is provided and solely kept for settling fair claims, for genuine users and for token stolen, lost or hacked with enough evidence and proof.

According to one aspect of the invention, there is provided a mechanism of an insurance pool, which is used once it is ratified by the supervisor-chain and sent to governance committee for redressal.

According to an aspect of the invention, mechanism of an insurance pool is in place which is replenished at regular interval to maintain the said reserve.

According to an aspect of the invention, mechanism of a meta governance is put in place for governance via voting and or administrative privilege to set aside a said sum for the insurance pool.

According to one more aspect of the invention, mechanism of improved multi-layer security envelope in the blockchain system is provided with fortified re-validation by means of neutral and disconnected set of users who have no connection with the mainchain.

According to another aspect of the invention, mechanism of auto policing and dynamic grievance addressing mechanism is provided without user intervention.

How the supervisor-chain (S-Chain) validates the main Blockchain, as secondary layer during mining, ensuring enhanced security powered by PoW with a built in Insurance pool, incentive scheme etc can be summarized as under:

Step-1: Main chain will progress with its basic function of adding transactions to block, getting the block validated and getting in committed to chain.

Step-2: S-Chain will then come into play. It will pick up committed blocks and re-validates all the transactions and their hashes to ensure the validators on the main chain have done the job right.

Step-3: Incase some discrepancy is found during the block validation at the cascading parallel chain (S-Chain), it will intimate the governance function of the said discrepancy.

Step-4: The governance function will now kick in and will do the 2 specific items viz. i) It will run through the run-engine which is part of the meta-governance and ii) It will allow for administrative intervention to potentially settle the raised grievance.

the

Step-5: The erroneous claims or issue will be settled in accordance of the meta-governance. It could be loss of asset due to hacking, or illegally claimed double spending etc.

Step-6: The claims are then settled from the insurance pool that's kept aside as part of the S-Chain insurance cover.

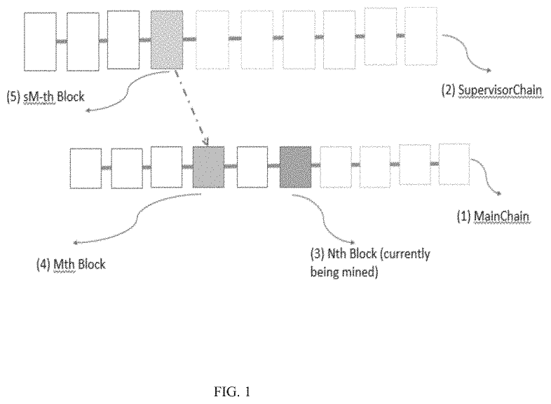

FIG. 1 showcases both the main chain 1 and the supervisor-chain 2 which is shown in cascaded fashion. As shown in FIG. 1, a double block chain is a parallel running system, which are cascaded w.r.t blocks being committed. The second chain called the supervisor-chain 2 or S-chain will always lag the main chain and will come into play, when the primary chain block are committed. In the diagram if in real-time Nth block 3 is being mined or under-work in the main-chain, then the S-chain 2 will be working on an equivalent of Mth block 4 (on main chain) which will be sM-th block 5. What the S-chain 2 is doing in essence is re-validating the transaction details again with a separate set of validators.

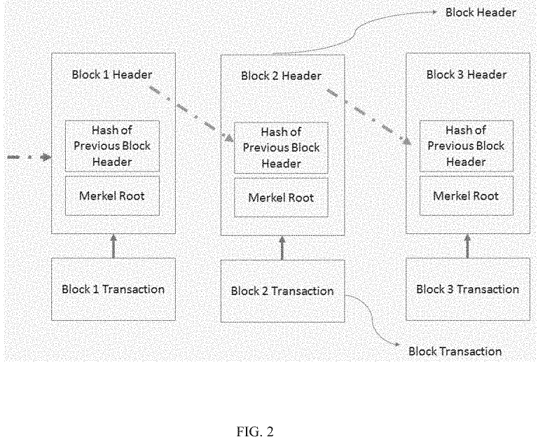

FIG. 2 Shows Blocks with connected block hash and merkle tree. Referring to FIG. 2 which shows a reference architectural diagram of a standard block chain, comprises of block-header and block-body. Block-header is the place where hash details of previous header, hash of merkle root etc. are stored to be able to create the mathematical connection between the blocks and ensures any changes to any of the blocks will break the entire sequencing and hence the block-chain itself, rendering it useless. In this case there will be 2 set of blockchain, which are independent and not inter-connected, but will ensure to work towards strengthening the validation from an overall solution stand-point.

### Uniqueness of the Invention

The SCVF-01 framework also provides a way to penalize a wrong behavior making it unattractive for the non-fair-user (NFU) to indulge in non-fair practice. The penalty could be increased cost of transaction, varying duration of prohibition on the network, suspension to operate a node, or be part of any validation scheme.

The SCVF-01 framework also provides a way to set aside an insurance pool, which is a combination of various crypto currencies in a basket (to ensure it is well headed and protected from steep movement in a single currency).

We have brought out the novel features of the invention by explaining some of the preferred embodiments under the invention, enabling those skilled in the art to understand and visualize our invention. It is also to be understood that the invention is not limited in its application to the details set forth in the above description. Although the invention has been described in considerable detail with reference to certain preferred embodiments thereof, various modifications can be made without departing from the spirit and scope of the invention as described herein above and as defined in the following claims.

We claim:

1. System of validation of block chain by secondary chain having incentivization and insurance coverage powered by Proof of Work, wherein the secondary chain functions as supervisory chain connected to a set of nodes where transactions are recorded and validated, is a cloud based hardware machine comprising a memory device; a processing device operatively coupled to the memory device; a storage and other connecting serial and parallel logical buses for transmission of data between various hardware components wherein the processing device is configured to execute computer-readable program code to ensure the working of double validation process, and once the system has committed the block for validating the transactions, the Supervisory-Chain picks up committed blocks and re-validates all the transactions and their hashes to ensure that the validators have done the right job on the main block chain.

2. The system of claim 1, wherein the custom hardware device deployed in the supervisor-chain (S-Chain) and main-chain, will monitor the health of their respective network and also perform data analytics and other algorithmic predictions based on the type of transactions and user data that form the transaction set for the blocks.

3. The system of claim 1, wherein it is based on SCVF-01 (Secondary Chain Validation framework), using supervisor-chain (S-Chain) for double-validation using a Proof-Of-Work algorithm with an integrated insurance pool built in.

4. The system as claimed in claimed in claim 1, wherein the system provides unique double layer security framework using two cascaded layering of consensus proof mechanism in a private and permissioned block chain environment.

5. The system of claim 1, wherein the system provides unique double layer security framework using two cascaded layering of consensus proof mechanism in a public block chain environment.

6. The system of claim 1, wherein means are there for providing incentive on the supervisor-chain by means of mining reward token, using Proof of Work or a similar consensus model to ensure that they continue to do the supervision work and flag transactions that are suspicious or they find a NFU (Non-Fair-User) who individually or in conjunction with a group trying to game the platform.

7. The system of claim 1, wherein an additional layer of decentralized on-chain governance layer, which is based on re-validation of validated transactions, is provided.

8. The system of claim 11, wherein an additional layer of non-decentralized off-chain governance layer, which is based on re-validation of validated transactions, is provided.

9. The system of claim 1, wherein there is a built in insurance pool having a part of the token raised and solely kept for rewarding the community and for settling fair claims, for genuine users and for token stolen, lost or hacked with enough evidence and proof.

10. The system of claim 1, wherein there is provided a mechanism of an insurance pool, which is used once it is ratified by the supervisor-chain and send to governance committee for redressal and the insurance pool is replenished at regular interval to maintain the said reserve.

11. The system of claim 1, wherein a meta governance is put in place for governance via voting or using the administrative privilege to set aside a sum for the insurance pool.

12. The system of claim 1, wherein multi-layer security envelope in the block chain system is provided with fortified re-validation by means of neutral and disconnected set of users who have no connection with the main chain.

13. A method of validation of main block chain by secondary chain having incentivization and insurance coverage powered by Proof of Work, comprising the steps of:
a) progressing with its basic function of adding transactions to block, getting the block validated and getting in committed to the chain, by the main chain;
b) up committed blocks by the S-Chain and re-validates all the transactions and their hashes to ensure the validators on the main chain have done the job right;
c) intimating the governance function of the discrepancy, incase some discrepancy is found during the block validation by the cascading parallel chain (S-Chain);
d) kicking in the governance function and does the 2 specific activities of:
e) running through the run-engine which is part of the meta-governance and
f) allowing for administrative intervention to potentially settle the raised grievance;
g) settling the erroneous claims or issue that could be loss of asset due to hacking, or illegally claimed double spending, in accordance of the meta-governance; and
h) settling the claims from the insurance pool that's kept aside as part of the S-Chain insurance cover.

14. The method of claim 13, wherein a true and new layer of security is created which has been missing in the block chain platform ecosystem and allows increased security and trust for users of the network, and increased avenues to flag dodgy transactions, to call out non-fair users (NFU), provides incentive on the supervisor-chain by means of mining reward token and also bake in a mechanism where there is always an insurance pool that's kept aside as contingency for taking up fair-users, if they have been cheated or if for some reason there has been a breach and a fair-user has lost some of his crypto assets.

15. The method of claim 13, wherein parallel and cascaded mechanism run two distinct consensus algorithms one for main block chain and the other for the supervisor chain and tuned by administrative levers to manage the cascading window frame.

16. The method of claim 13, wherein the supervisor-chain revalidates the already validated or committed user transaction by an out of chain governance mechanism.

17. The method of claim 13, wherein supervisor chain powered by Proof of Work, validates the already validated or committed user transaction by an on-chain governance mechanism and impose penalty or award incentive at increased cost of transaction.

18. The method of claim 13, wherein Proof of work as a consensus model incentivizes behaviours outside of the main-chain in a block chain platform.

19. The methods of claim 13, wherein supervisor chain powered by Proof of Work revalidates the already validated or committed user transaction by an on-chain governance mechanism and impose penalty or award incentive at increased cost of transaction.

20. The method of claim 13, wherein Off-chain governance mechanism impose penalty for non-fair users, by way of reduced Fair-Quotient-Score (FQS).

21. The method of claim 13, wherein Off-chain governance mechanism impose penalty for non-fair-users (NFU) by way of banning the user for a temporary period commensurate to the laid-out governance rule and also includes penalty for non-fair users, by way of permanently banning non-fair-user (NFU) for repeat offense and if falls under the governance purview of banning.

22. The method of claim 13, wherein the insurance pool, provided therein is used once it is ratified by the supervisor-chain and sent to governance committee for redressal and the insurance pool is replenished at regular interval to maintain the said reserve.

23. The method of claim 13, wherein auto policing and dynamic grievance addressing are carried out without user intervention.
